(19) United States
(12) Patent Application Publication
(10) Pub. No.: US 2021/0257601 A1
(43) Pub. Date: Aug. 19, 2021

(54) TAPERED BATTERY FILL PORT

(71) Applicant: Pacesetter, Inc., Sylmar, CA (US)

(72) Inventor: John Duggan, Greenville, SC (US)

(21) Appl. No.: 16/997,907

(22) Filed: Aug. 19, 2020

Related U.S. Application Data
(60) Provisional application No. 62/977,113, filed on Feb. 14, 2020.

(51) Int. Cl. H01M 2/36; H01M 2/04

(52) U.S. Cl. CPC H01M 2/365; H01M 2/362; H01M 2/0456

(57) ABSTRACT

The battery includes a container that holds an electrode assembly. The container has an opening that extends from an external side of the container to an internal side of the container. A plug is configured to be inserted into the opening. The plug has a plug taper configured such that a width of the plug decreases linearly from an external side of the plug to an internal side of the plug. The plug taper is present on the plug before the plug is inserted into the opening.

### RELATED APPLICATIONS

This application is related to U.S. Provisional Patent Application Ser. No. 62/977,113, filed on Feb. 14, 2020, entitled “Tapered Battery Fill Port,” and incorporated herein in its entirety.

### FIELD

The invention relates to electrochemical energy storage devices. In particular, the invention relates to batteries.

### BACKGROUND

Many batteries have a container that includes a fill port. A liquid electrolyte is added to the interior of the container through the fill port and the fill port is then sealed. These fill ports can be a source of leakage of the electrolyte from the battery. This leakage is undesirable and can be dangerous in many applications such as implantable medical devices. These leaks can have a variety of different sources such as deformation of the fill port while sealing the fill port, difficulty of fabricating the fill port components with the precise dimensions needed for proper functioning of the components, complexity of the fill port construction, and difficulty of fabricating sealing mechanisms such as welds on the fill port structure.

As a result, there is a need for simplified battery fill ports with reduced levels of leakage.

### SUMMARY

A battery includes a container that holds an electrode assembly. The container has an opening that extends from an external side of the container to an internal side of the container. A plug is configured to be inserted into the opening. The plug has a plug taper configured such that a width of the plug decreases linearly from an external side of the plug to an internal side of the plug. The plug taper is present on the plug before the plug is inserted into the opening.

Another embodiment of the battery includes a container that holds an electrode assembly. The container has one or more lateral sides that define an opening that extends from an external side of the container to an internal side of the container. A plug is received in the opening. The interface between the plug and the lateral sides of the container are constructed as a self-holding taper. In some instances, the self-holding taper is a Jacobs taper or a Morse taper.

### BRIEF DESCRIPTION OF THE FIGURES

FIG. 1A is a cross section of a portion of a battery that includes a fill port. The fill port includes an opening that extends through the container and a plug that can be inserted into the opening.

FIG. 1B is a topview of a cross section of the portion of the battery shown in FIG. 1A before the plug is inserted into the opening. The cross section in FIG. 1B is taken along the line labeled B in FIG. 1A.

FIG. 1C is a cross section of the portion of a battery shown in FIG. 1A after the plug is inserted into the opening.

FIG. 1D is a topview of the portion of the battery shown in FIG. 1C.

FIG. 2A is a cross section of a portion of a battery that includes a fill port with a plug received in an opening.

FIG. 2B is a cross section of a portion of a battery that includes a fill port where an interface between a plug and lateral sides of an opening include a gap region and a contact region.

FIG. 3 is cross section of a portion of a battery that includes a fill port. The fill port includes an opening that extends through the container and a plug that can be inserted into the opening. The container includes a projection that extends away from a base portion of the container.

FIG. 4A is a cross section of a portion of a battery container that includes a plug received in an opening in a container.

FIG. 4B is a cross section of the battery shown in FIG. 4A taken looking in the direction labeled B in FIG. 4A.

FIG. 4C is a cross section of the battery shown in FIG. 4B after a handle is detached from a plug body.

FIG. 5A is a cross section of a portion of a battery container that includes a plug received in an opening in a container. The plug includes a pin integrated with a plug body.

FIG. 5B is a cross section of a portion of a battery container that includes a plug received in an opening in a container. The plug includes a pin that is discrete from a plug body and received in a blind hole on the plug body.

FIG. 5C is a cross section of a portion of a battery container that includes a plug received in an opening in a container. The plug includes a pin that is discrete from a plug body and received in a counterbored through-hole on the plug body.

FIG. 5D is a cross section of a portion of a battery container that includes a plug received in an opening in a container. The plug includes a pin that is discrete from a plug body and received in a counterbored through-hole on the plug body.

FIG. 5E is a cross section of a portion of a battery container that includes a plug received in an opening in a container. The plug includes a pin that is discrete from a plug body and received in a straight-walled through-hole on the plug body.

FIG. 6 is a cross section of a generalized example of a battery that can include a fill port.

### DESCRIPTION

A battery includes a container that holds an electrode assembly. The container includes one or more fill ports. Each fill port includes an opening that extends through the container. The opening is tapered such that a width of the opening decreases as the opening approaches the interior of the container. Each fill port also includes a plug with a plug taper. At least a portion of the plug is configured to be inserted into the opening with the plug taper positioned in the opening taper.

The plug taper is present on the plug before the plug is received in the opening. Additionally, the plug taper can be complementary or substantially complementary to the taper of the opening. As a result, the plug and/or opening need not be substantially deformed as a result of inserting the plug into the opening. Accordingly, the level of force needed to insert the plug into the opening is greatly reduced when compared with fill ports that require interference fits or deformation of components. The reduced force levels needed to seal the fill port decrease the opportunity for damage to the battery and accordingly reduce the opportunity for leakage from the battery. The opening taper and the plug taper can be constructed as a self-holding taper. The use of a self-holding taper can provide a more reliable seal and lower costs associated with sealing the opening.

Additionally, the use of the tapers allows variability in the fabrication of the fill port. For instance, the fabrication process can be configured such that variations in the dimensions of the opening and/or of the plug determine the depth that the plug sits in the opening. For instance, these fabrication variations can determine whether an external side of the plug is flush with an external side of the container or is recessed relative to the external side of the container. The change in depth of the plug with the opening generally does not affect the integrity of the seal in the fill port. As a result, the fill port is very tolerant of inconsistent component fabrication.

An exposed interface between the plug and the container can be further sealed with sealing mechanisms such as welding. When the external surface of the plug is flush with the external surface of the container, the interface between the plug and the container is easily accessed allowing for easy formation of the sealing mechanisms. Additionally, when the plug is recessed in the opening and the lateral sides of the opening define a taper, an obtuse angle is formed between the external surface of the plug and the lateral sides of the opening. The presence of the obtuse angle facilitates the process of cleaning the interface and forming the sealing mechanism at the interface. As a result, the structure of the exposed interface also facilitates the formation of the seal mechanism.

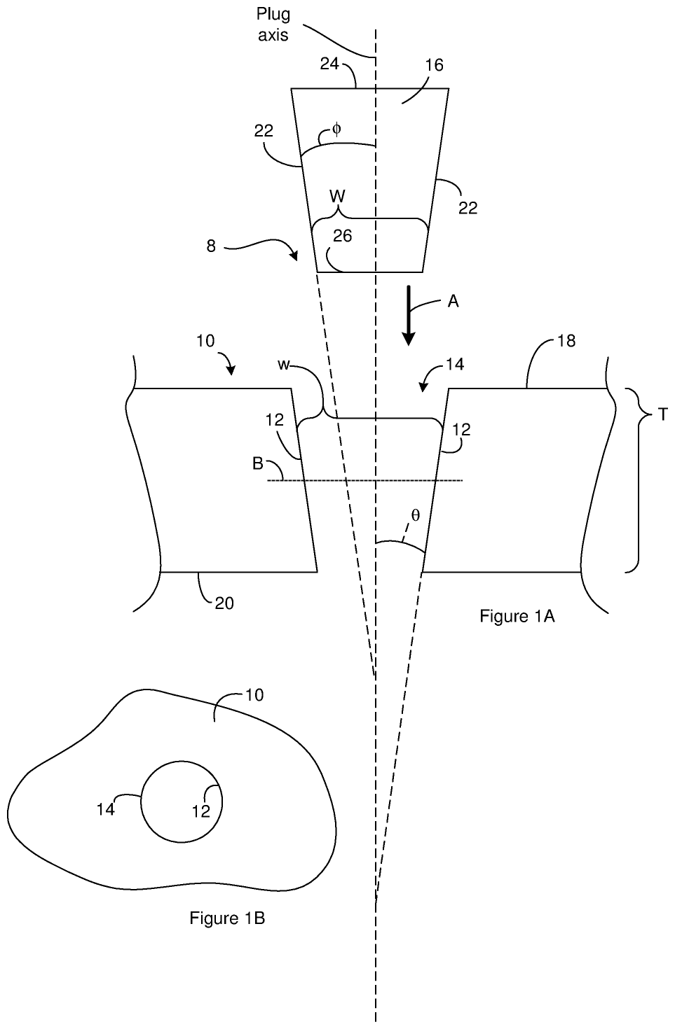

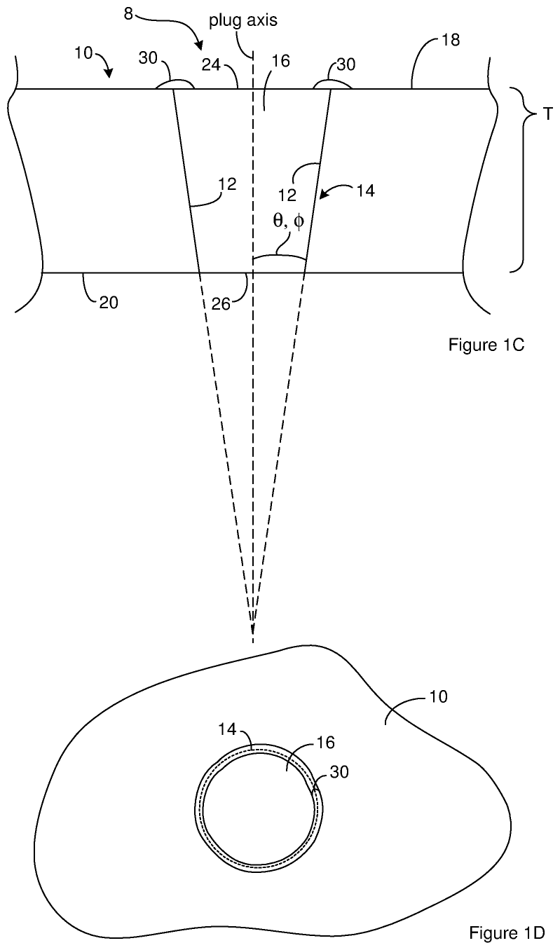

FIG. 1A is a cross section of a portion of a battery that includes a fill port 8. The battery includes a container 10 with one or more lateral sides 12 that define an opening 14 that extends through the container 10. The fill port 8 includes a plug 16 that can be inserted into the opening 14. FIG. 1B is a topview of a cross section of the portion of the battery shown in FIG. 1A before the plug 16 is inserted into the opening 14. The cross section in FIG. 1B is taken along the line labeled B in FIG. 1A. In some instances, the lateral shape of the opening 14 is circular as show in FIG. 1B. The one or more lateral sides 12 taper from an external side 18 of the container 10 to the internal side 20 of the container 10. The opening 14 is tapered such that the opening 14 narrows as it approaches the internal side 20 of the container 10.

In some instances, the opening 14 taper is a linear taper as illustrated in FIG. 1A. For instance, the width of the opening 14 (labeled w in FIG. 1A) can be a linear function of the depth of the taper in the opening 14. The linear function need not change between the external side 18 of the container 10 and the internal side 20 of the container 10. As a result, when the lateral shape of the opening 14 is circular, the lateral side 12 of the opening 14 can have the shape of the perimeter of a tapered cylinder.

The plug 16 is configured to be inserted into the opening 14 as shown by the arrow labeled A in FIG. 1A. The plug 16 has one or more lateral sides 22 that define a taper from an external side 24 of the plug 16 to an internal side 26 of the plug 16. The plug 16 can be tapered such that when the plug 16 is received in the opening 14, the plug 16 narrows as it approaches the internal side 20 the container 10. The lateral shape of the plug 16 can be complementary to the lateral shape of the opening 14. For instance, when the lateral shape of the opening 14 is circular, the lateral shape of the plug 16 can be circular.

In some instances, the plug taper is a linear taper as illustrated in FIG. 1A. For instance, the width of the plug 16 (labeled W in FIG. 1A) can decrease linearly moving from the external side 24 of the plug 16 to the internal side 26 of the plug 16. The linear function need not change between the external side 24 of the plug 16 and the internal side 26 of the plug 16. The shape of the plug 16 can be can be complementary to the shape of the opening 14. For instance, when the sides of the opening 14 have the shape of the perimeter of a tapered cylinder, the plug 16 can have the shape of a tapered cylinder.

FIG. 1C and FIG. 1D illustrate the fill port 8 after the plug 16 is received in the opening 14. FIG. 1C is a cross section of the portion of a battery shown in FIG. 1A after the plug 16 is inserted into the opening 14. FIG. 1D is a topview of the portion of the battery 10 shown in FIG. 1C. In some instances, a sealing mechanism 30 is placed over the interface between the plug 16 and the container 10 so as to provide a liquid seal between the container 10 and the plug 16. In FIG. 1D, the interface between the plug 16 and the container 10 is illustrated by a dashed line due to its location under the sealing mechanism 30. In some instances, the sealing mechanism 30 contacts the container 10 and the plug 16 and/or covers the interface between the container 10 and the plug 16. As a result, the sealing mechanism 30 can prevent or reduce leakage of an electrolyte from inside the container 10 through the interface between the plug 16 and the sides of the opening 14. Suitable sealing mechanisms 30 include, but are not limited to, welds, brazes, solders, and coatings. Suitable welding techniques include, but are not limited to, laser welding, resistance welding, TIG welding, electron beam welding, and solid state welding methods including, but not limited to, ultrasonic or friction type welding methods.

The angle of the opening taper is labeled 0 in FIG. 1A. The angle of the opening taper is measured between a side of the opening taper and a plug axis. The plug axis can be an axis of symmetry of the plug or a central axis of the plug. In some instances, the plug axis is perpendicular or substantially perpendicular to the external side 24 of the plug 16 and/or to the internal side 26 of the plug 16. The angle of the plug taper is labeled it, in FIG. 1A. The angle of the plug taper is measured between a lateral side of the plug and the plug axis. Suitable angles for the opening taper (θ) include, angles greater than 0 degrees and/or less than 20 degrees or less than 10 degrees. Suitable angles for the plug taper (ϕ) include angles greater than 0 degrees and/or less than 20 degrees or less than 10 degrees.

In some instances, the angle for the opening taper (θ) and the angle for the plug taper (ϕ) are selected such that the interface between the plug 16 and the lateral side(s) 12 of the opening 14 is a self-holding taper such as a Morse taper or a Jacobs taper. Self-holding tapers are tapers where a tapered male member is held in a tapered female member against the action of gravity as a result of tapering of the external of the male member and the complementary tapering of the female member. The self-holding characteristic can be achieved with deformation, or without substantial deformation, of the plug 16 or the opening 14. The inventors have found that the use of self-holding tapers provide enhanced sealing of the interface between the container 10 and the plug 16 than can be achieved with cylindrically shaped fill port geometries that receive a ball and/or plug with a non-tapered geometry. Additionally, the inventors have found that the use of self-holding tapers combined with a sealing mechanism 30 provides sealing of the interface between the container 10 and the plug 16 that is suitable for use in applications such as implantable medical devices.

Although the choice of materials, respective hardness values, and respective surface finish values may influence the effective angle at which a self-holding mate condition is achieved, a self-holding taper can generally be achieved with an opening taper angle (θ) greater than 0 degrees and less than 5 degrees and a plug taper angle (ϕ) greater than 0 degrees and/or less than 5 degrees. A Jacobs taper can be achieved with opening taper angles (θ) greater than 1.41 degrees and less than 2.33 degrees and plug taper angles (ϕ) greater than 1.41 and/or less than 2.33 degrees. A Morse taper can be achieved with opening taper angles (θ) approximately greater than 1.43 degrees and approximately less than 1.51 degrees and plug taper angles (ϕ) greater than 1.43 degrees and approximately less than 1.51 degrees.

Suitable materials for the container 10 include, but are not limited to, titanium, aluminum, stainless steel, and other metals. Suitable materials for the plug 16 include, but are not limited to, titanium, aluminum, stainless steel, and other metals. In some instances, the plug 16 and the container 10 are constructed of the same material. Suitable approaches for forming the opening 14 in the material for the container 10 include but, are not limited to, piercing, punching or drilling the material followed by creating the taper by reaming, broaching, or flaring. Other suitable approaches for creating the opening 14 in the material for the container 10 include electrical discharge machining (EDM), or machining with a tapered mill. Suitable approaches for fabricating the plug 16 include, but are not limited to, automatic screw machines, manually controlled or computer numerically controlled (CNC) lathes, manually controlled or CNC milling machines, or additive manufacturing methods.

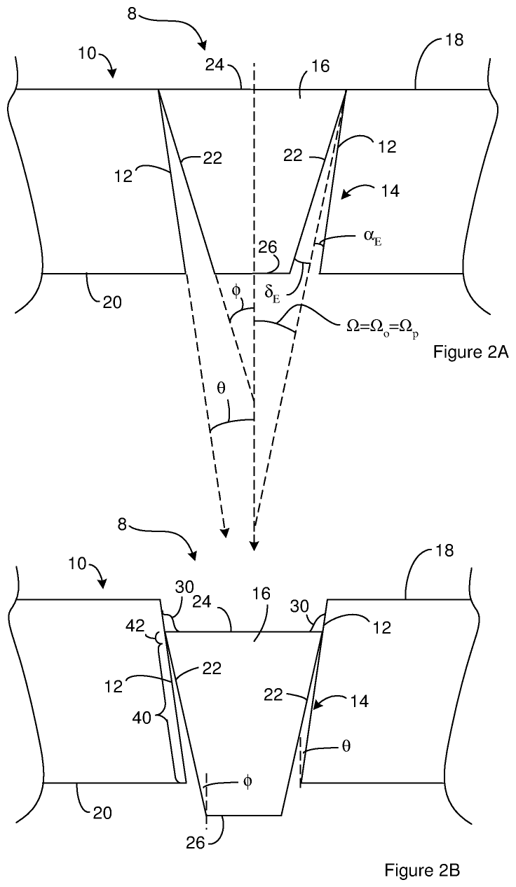

In some instances, the opening taper angle (θ) is equal to the plug taper angle (ϕ) as is illustrated in FIG. 1C. However, an exact match between the opening taper angle (θ) and the plug taper angle (ϕ) is frequently not possible due to inconsistencies in the processes of fabricating the plug 16 and/or the opening 14. As a result, the opening taper angle that actually results (θ) can fall within a range from θ=Ω₀−α_{E} to θ=Ω₀ where Ω₀ represents the value that is desired for the opening taper angle and α_{E} represents the spread in angular range that the opening taper angle experiences as a result of fabrication inconsistencies. The plug taper angle that actually results (ϕ) can fall within a range from ϕ=Ωₚ to ϕ=Ωₚ+δ_{E}, where Ωₚ represents the value that is desired for the plug taper angle and δ_{E}, represents the spread in angular range that the plug taper angle experiences as a result of fabrication inconsistencies. In some instances, α_{E}≤0.5Ωₒ and/or δ_{E}≤0.5Ωₚ, or α_{E}≤0.25Ω₀ and/or δ_{E}≤0.25Ωₚ. In some instances, the value that is desired for the opening taper angle (Ωₒ) is equal to the value that is desired for the plug taper angle (Ωₚ). The relationship between the angles ϕ, θ, Ωₚ, Ωₒ, α_{E}, and δ_{E}, is shown in FIG. 2A.

The dimensions of the fill port 8 can be selected such that the fill hole includes a contact region 42 above a gap region 40. For instance, when there is a gap between a portion of the plug 16 and the lateral side(s) 12 that define the opening 14 and another portion of the plug 16 contacts the lateral side(s) 12 that define the opening 14, the dimensions of the fill port 8 are selected such that the area of contact is located between the external side 24 of the plug 16 and the gap. In some instance, the area of contact is located at the top of the plug. As an example, FIG. 2B is a cross section of a portion of a battery that includes a fill port 8. The fill port 8 includes a gap region 40 where the plug 16 is separated from the lateral side(s) 12 of the opening 14. The fill port 8 also includes a contact region 42 where the plug 16 contacts the lateral side(s) 12 of the opening 14. The external side 24 of the plug 16 is positioned within the opening 14. The contact region 42 is located closer to the external side 24 of the plug 16 than the gap region 40. The gap region 40 and the contact region 42 can each surround the plug 16.

When a liquid electrolyte is positioned in the container 10, the gap region 40 can be exposed to the electrolyte. For instance, the electrolyte can be positioned within the gap. As an example, the electrolyte can contact the portion of the plug 16 that defines the gap region 40 and/or the portion of the lateral side(s) 12 that define the gap region 40.

The location of a contact region 42 above a gap region 40 can be achieved when the width of the opening (w) at the top of the opening exceeds the width of the plug 16 at the top of the plug and/or at the external side 24 of the plug and ϕ>θ. The condition that ϕ>0 is satisfied when Ωₚ+δ_{E}>Ωₒ−α_{E}. The value of α_{E} and δ_{E} can be a function of the method chosen for fabricating the opening 14 and the plug 16. Additionally, the value of α_{E} and δ_{E} can be a function of the size of the fill port 8. For instance, the values of α_{E} and δ_{E} can decrease as the width of the opening 14 increases because the opening 14 and/or plug 16 can become more difficult to fabricate as the parts become smaller. In some instances, the value of Ωₚ and Ωₒ are selected in view of the values for α_{E} and δ_{E} such that Ωₚ+δ_{E}>Ωₒ−α_{E}.

As is evident from a comparison of FIG. 2A and FIG. 2B, the opening taper angle (θ) and a plug taper angle (ϕ) that result from the selected angle variables Ωₚ, Ωₒ, α_{E} and δ_{E} can result in the external side 24 of the plug 16 being flush with the external side 18 of the container 10 or being recessed relative to the external side 18 of the container 10. The angle variables can also be selected such that the external side 24 of the plug 16 is proud of the external side 18 of the container 10; however, being flush or recessed can facilitate sealing of the interface between the plug 16 and the container 10. For instance, the plug 16 being flush or recessed can facilitate forming a weld as a sealing mechanism 30 and/or removal of electrolyte from the interface between the plug 16 and the container 10.

The values of Ωₚ, Ωₒ, α_{E} and δ_{E} can be selected to achieve the desired self-holding properties. In some instances, the value of α_{E} is greater than 0° and/or less than 0.7° or 1.5° and/or the value of δ_{E} is greater than is greater than 0° and/or less than 0.7° or 1.5°. Additionally or alternately, in some instances, the value of Ωₚ is less than or equal to 10° or 3° or 2.33° degrees and/or greater than or equal to 1.41° or greater than 0° and/or the value of Ωₒ is less than or equal to 10° or 3° or 2.33° and/or greater than or equal to 1.41° or greater than 0°. In one example, the value of α_{E} is 1°, the value of δ_{E} is 1°, the value of Ωₚ is 2.5°, and the value of Ωₒ is 2.5°.

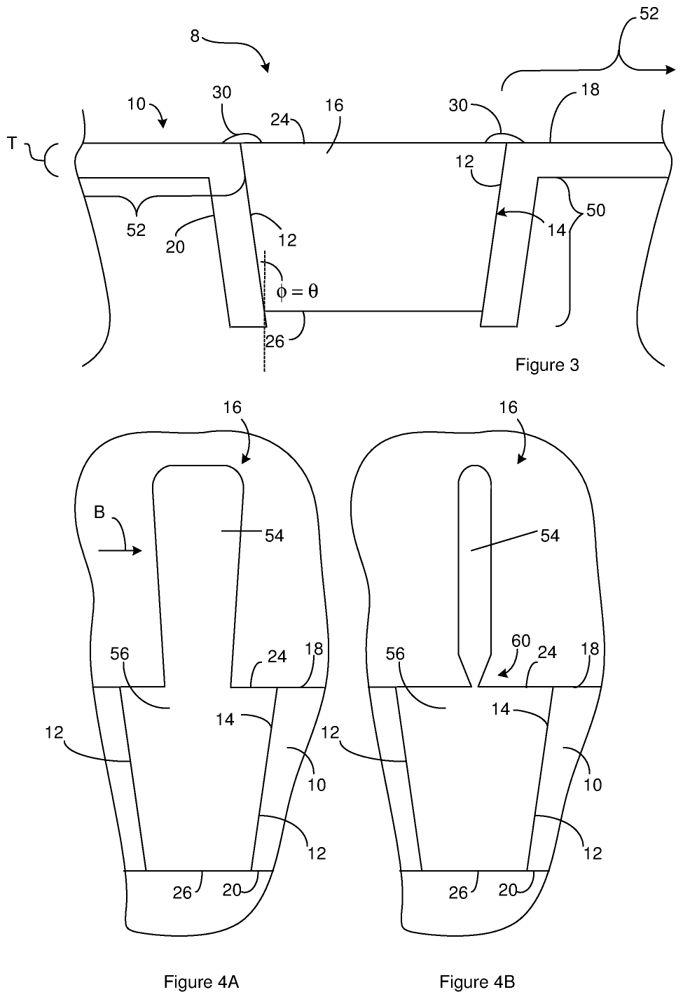

The container 10 need not be flat. For instance, the opening 14 can be formed in a portion of the container 10 that extends into the internal of the container 10. As an example, FIG. 3 is cross section of a portion of a battery that includes a fill port 8. The fill port includes an opening that extends through the container and a plug that can be inserted into the opening. The container 10 includes a projection 50 that extends away from a base portion 52 of the container 10. The illustrated projection 50 extends into the internal of the container 10 but can extend away from the base portion 52 into the external of the container 10. The opening 14 extends through the projection 50 such that the projection 50 surrounds the opening 14. The base portion 52 of the container 10 can surround the projection 50.

The projection 50 can increase the size of the contact region between the plug and the lateral sides and can accordingly increase the quality of the seal at the interface of the container 10 and the plug 16. As a result, the use of a fill port 8 with a projection 50 may be desirable as the thickness of the portion of the container 10 that includes the opening 14 becomes thinner. Suitable methods of forming the projection 50 include, but are not limited to, punching, coining, broaching, and flaring. The taper angle (ϕ) and the opening angle (θ) for the plug 16 and container 10 shown in FIG. 3 can be selected as described in the context of FIG. 1A through FIG. 2B.

The thickness of the container 10 is labeled T in FIG. 1A and FIG. 1C and FIG. 3. In some instances, the thickness of the container 10 is greater than 0.005 inches and/or less than 0.10 inches. In some instances, the width of the opening 14 at the external surface of the container 10 is greater than 0.010 inches and/or less than 0.070 inches. In some instances, the width of the plug 16 at the external surface of the plug 16 is greater than 0.010 inches and/or less than 0.070 inches.

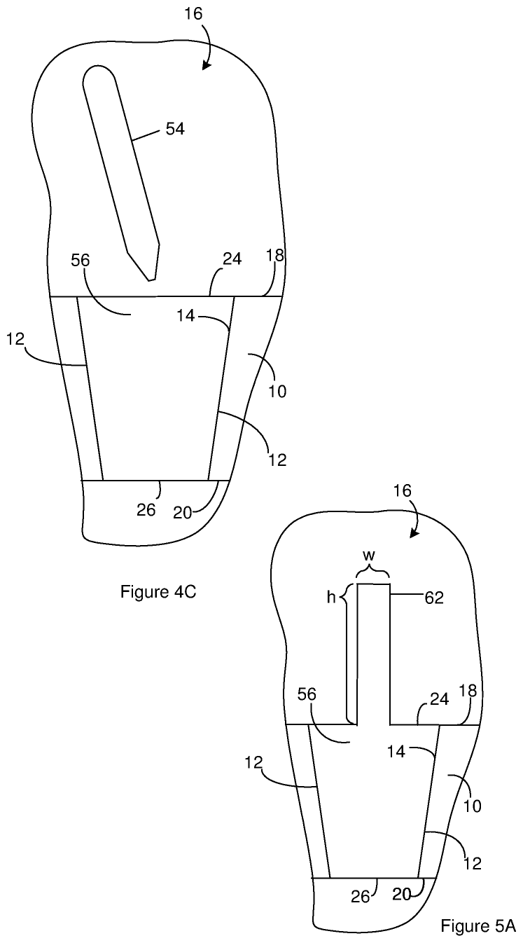

In some instances, the plug 16 can include a handle 54 as illustrated in FIG. 4A and FIG. 4B. FIG. 4A is a cross section of a portion of a battery that includes a plug 16 received in an opening 14 in a container 10. FIG. 4B is a cross section of the battery shown in FIG. 4A taken looking in the direction labeled B in FIG. 4A. The plug 16 includes a handle 54 extending from a plug body 56. The handle 54 can be used to insert the plug body into the opening 14 in the container 10. For instance, the handle 54 can be mechanically or manually held while inserting the plug body into the opening 14.

As is evident from FIG. 4B, the handle 54 can optionally include a region of weakness 60 that can be used to disconnect different portions of the plug 16 from one another. For instance, the region of weakness 60 can be used to detach all or a portion of the handle 54 from the plug body as illustrated in FIG. 4C. Separating the different portions of the plug 16 from one another can be done with a mechanical device and/or manually. In some instances, separating the different portions of the plug 16 from one another includes bending the plug 16 at the region of weakness 60.

FIG. 4B illustrates the region of weakness 60 as a region where the thickness of the handle 54 decreases, however, other regions of weakness can be used. For instance, the region of weakness 60 can includes features that are not present in the other regions of the handle 54. Examples of features for a region of weakness 60 include, but are not limited to, holes, perforations, notches, and grooves.

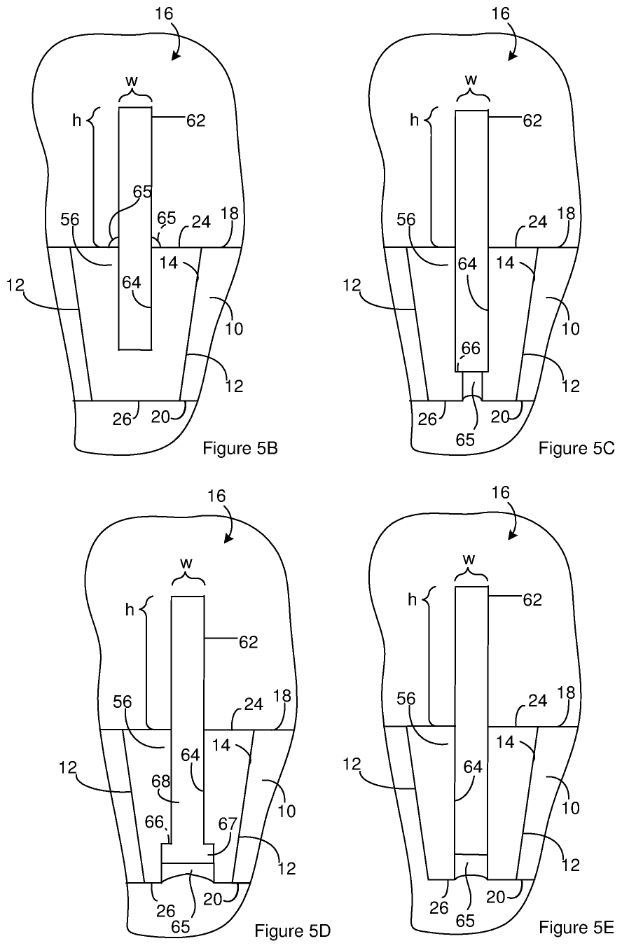

The plug can include a pin extending from the external side 24 of the plug body. The pin can serve as a terminal pin for a battery or as a handling device for inserting and/or fixing the plug body in the opening 14. As an example, FIG. 5A is a cross section of a portion of a battery container that includes a plug received in an opening in a container. The pin 62 is integral with the plug body 56. For instance, the material of the plug body 56 is continuous with the material of the pin 62.

The pin can be a discrete component from the plug body 56. As an example, FIG. 5B is a cross section of a portion of a battery container that includes a plug received in an opening in a container. The plug includes a pin 62 received in a hole 64 in the plug body 56. The illustrated hole 64 is a blind hole that extends only part way through the plug body 56. The pin 62 can be immobilized in the hole 64 using one or more immobilization mechanisms. For instance, the pin 62 can be immobilized relative to the hole 64 by one or more welds 65 that each contacts the pin 62 and the plug body 56 and/or by a press fit between the pin 62 and the one or more walls of the plug body 56 that define the hole 64.

The plug body 56 can have a through-hole that receives the pin 62. As an example, FIG. 5C is a cross section of a portion of a battery container that includes a plug received in an opening in a container. The plug includes a pin 62 received in a hole 64 in the plug body 56. The hole 64 is a through-hole. The through-hole includes a large width borehole and a narrow width borehole. A width of the large width borehole is greater than the width of the narrow width borehole. The large width borehole and the narrow width borehole can be concentric within the plug. Additionally or alternately, large width borehole is concentric with the plug axis and/or the narrow width borehole is concentric with the plug axis. The illustrated through-hole is a counterbored hole with a flat interface surface 66 that is perpendicular to the plug axis at an interface between the large width borehole and the narrow width borehole; however, the through-hole can be a countersunk hole with a tapered interface surface 66 at the interface. The pin 62 can be immobilized in the hole 64 using one or more immobilization mechanisms. For instance, the pin 62 can be immobilized relative to the hole 64 by one or more welds 65 that each contacts the pin 62 and the plug body 56 and/or by a press fit between the pin 62 and the one or more walls of the plug body 56 that define the hole 64.

FIG. 5C illustrates the pin received in the large width borehole, however, all or a portion of the narrow width borehole can receive the pin 62. As an example, FIG. 5D is a cross section of a portion of a battery container that includes a plug received in an opening in a container. The plug includes a hole 64 that is a through-hole. The through-hole includes a large width borehole and a narrow width borehole. A width of the large width borehole is greater than the width of the narrow width borehole. The large width borehole and the narrow width borehole can be concentric within the plug. Additionally or alternately, large width borehole is concentric with the plug axis and/or the narrow width borehole is concentric with the plug axis. The large width borehole is between the internal side 26 and the narrow width borehole. The illustrated through-hole is a counterbored hole with a flat interface surface at an interface between the large width borehole and the narrow width borehole; however, the through-hole can be a countersunk hole with a tapered interface surface at the interface.

The pin 62 includes a flange region 67 that extends outward from a pin body 68. The pin body 68 is received in the narrow width borehole. The flange region 67 is positioned in the large width borehole and is seated against the interface surface 66. Accordingly, the flange region 67 can be in contact with the interface surface 66. The pin 62 can be immobilized in the hole 64 using one or more immobilization mechanisms. For instance, the pin 62 can be immobilized relative to the hole 64 by one or more welds 65 that each contacts the pin 62 and the plug body 56 and/or by a press fit between the pin 62 and the one or more walls of the plug body 56 that define the hole 64.

The plug body 56 can receive the pin 62 in a through-hole that excludes a countersink or a counterbore. As an example, FIG. 5E is a cross section of a portion of a battery container that includes a plug received in an opening in a container. The plug includes a pin 62 received in a hole 64 in the plug body 56. The hole 64 is a straight-walled hole. The pin 62 can be immobilized in the hole 64 using one or more immobilization mechanisms. For instance, the pin 62 can be immobilized relative to the hole 64 by one or more welds 65 that each contacts the pin 62 and the plug body 56 and/or by a press fit between the pin 62 and the one or more walls of the plug body 56 that define the hole 64.

The width of the pin is labeled w in FIG. 5A through FIG. 5E. A suitable width (w) for the pin 62 includes, a width greater than 0.010″ and less than 0.030″. The pin 62 extends away from the plug body by a height labeled h in FIG. 5A through FIG. 5E. A suitable height (h) for the pin 62 includes, a height greater than 0.030″ and less than 0.750″.

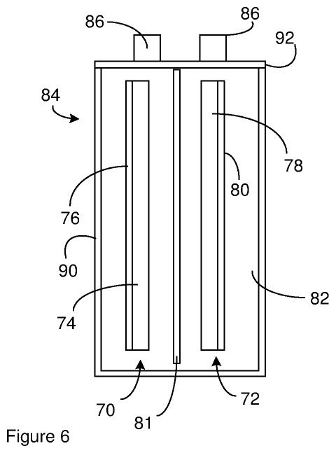

FIG. 6 is a cross section of a generalized example of a battery that can include a fill port. The battery includes one or more first electrodes 70 alternated with one or more second electrodes 72. The first electrodes 70 include a first active medium 74 on a first current collector 76 and the second electrodes 72 include a second active medium 78 on a second current collector 80. The first electrodes 70 can be cathodes and the second electrodes 72 can be anodes or the first electrodes 70 can be positive electrodes and the second electrodes 72 can be negative electrodes. One or more of the first electrodes and/or one or more of the second electrodes can be fabricated according to the disclosed fabrication process.

A separator 81 is positioned between adjacent first electrodes 70 and second electrodes 72. An electrolyte 82 is positioned in a container 10 so as to activate the one or more first electrodes 70 and the one or more second electrodes 72. The battery includes terminals 86 that can be accessed from outside of the container 10. Although not illustrated, the one or more first electrodes 70 are in electrical communication with one of the terminals 86 and the one or more second electrodes 72 are in electrical communication with another one of the terminals 86. In some instances, the one or more first electrodes 70 are in electrical communication with all or a portion of the container 10 and/or the one or more second electrodes 72 are in electrical communication with all or a portion of the container 10. In some instances where the one or more first electrodes 70 and/or the one or more second electrodes 72 are in electrical communication with the container 10, the container 10 serves as one or both of the terminals.

Although the battery is illustrated with the one or more first electrodes 70 and the one or more second electrodes 72 in a stacked configuration, the one or more first electrodes 70 and the one or more second electrodes 72 can be in another configuration such as a jellyroll configuration.

The container can include one or more fill ports constructed as disclosed above. The illustrated container 10 includes a case 90 and a cover 92, however, other constructions are possible. For instance, the container 10 can include multiple covers on a case, or multiple mating case portions. The one or more fill ports can be included on different components of the container. For instance, the fill port can be positioned on a cover and/or on a case. The one or more fill ports can be included on different components of the container. For instance, the fill port can be positioned on a cover and/or on a case.

In addition or as an alternative to container including one or more fill ports that include a plug, the battery can include one or more plugs that serve as one of the terminals 86. For instance, the plug body 56 and the pin 62 disclosed in the context of FIG. 5A through FIG. 5E can be electrically conducting. As a result, when the one or more first electrodes 70 are in electrical communication with all or a portion of the container 10 and/or the one or more second electrodes 72 are in electrical communication with all or a portion of the container 10, the plug body 56 can provide electrical communication between the container 10 and the pin 62. The electrical communication between the container 10 and the pin 62 allows the pin to serve as the battery terminal. Alternately, the pin 62 can serve as a terminal as a result of an alternate electrical pathway between the pin 62 and the one or more first electrodes 70 or the one or more second electrodes 72. For instance, electrical plug body 56 and/or the pin 62 can be electrically connected to the one or more first electrodes 70 or the one or more second electrodes 72.

In instances where the pin 62 serves as a terminal for the battery, using a pin 62 that is discrete from the plug body 56 allows for the use of materials other than that of plug body 56. Suitable materials for the pin 62 include, but are not limited to, metals such as titanium, aluminum, stainless steel, molybdenum, nickel, copper, alloys such as Superferrit®, Elgiloy® and alloys that include cobalt. Suitable materials for the plug body 56 include, but are not limited to, metals including titanium, aluminum, and stainless steel. When the pin 62 serves as a terminal for the battery and the pin 62 is integral with the plug body 56, suitable materials for the plug body 56 and the pin 62 include, but are not limited to, metals including titanium, aluminum, and stainless steel. When the pin 62 serves as a terminal for the battery and the pin 62 is discrete from the plug body 56, suitable materials for the plug body 56 include, but are not limited to, metals such as titanium, aluminum, stainless steel, and suitable materials for the pin 62 include, but are not limited to, metals such as titanium, aluminum, stainless steel, molybdenum, nickel, copper, and alloys such as Superferrit®, Elgiloy® and alloys that include cobalt.

The first active medium includes one or more cathode active materials selected from the group consisting of silver vanadium oxide (SVO), copper vanadium oxide, manganese dioxide, copper silver vanadium oxide (CSVO), carbon, fluorinated carbon, metal oxide and carbon monofluoride (CFx), metal oxide and carbon monofluoride, mixed SVO and CFx, cobalt oxide and nickel oxide, titanium disulfide, and can include other cathode active materials.

In addition to the one or more cathode active materials, the first active medium includes none, one, or more than one component selected from the group consisting of binder, electrical conductor, and diluent. Suitable binders include, but are not limited to, polymeric binders including fluoro-resin binders such as polytetrafluoroethylene (PTFE), polyvinylidene fluoride (PVDF), polyethylenetetrafluoroethylene (ETFE), a polyamide or a polyimide, and mixtures thereof. Suitable electrical conductors include, but are not limited to, acetylene black, carbon black, graphite, and metal powders of nickel, aluminum, titanium and stainless steel. Suitable diluents include, but are not limited to, ISOPAR.

Suitable first current collectors include, but are not limited to, meshes, screens, and foils. Suitable materials for the first current collector include, but are not limited to, copper, nickel, and nickel-plated steel, stainless steel, titanium, and combinations thereof.

In the example battery, the second electrode is an anode. The second active medium can include one or more anode active materials selected from the group consisting of materials capable of intercalating and de-intercalating lithium ions such as lithium metal and carbonaceous materials including any of the various forms of carbon such as coke, graphite, acetylene black, carbon black, glassy carbon, pitch carbon, synthetic carbon, mesocarbon microbeads, and mixtures thereof.

In addition to the one or more anode active materials, the second active medium includes none, one, or more than one component selected from the group consisting of binder, electrical conductor, and diluent. Suitable binders include, but are not limited to, polymeric binders including fluoro-resin binders such as polytetrafluoroethylene (PTFE), polyvinylidene fluoride (PVDF), polyethylenetetrafluoroethylene (ETFE), a polyamide or a polyimide, and mixtures thereof. Suitable electrical conductors include, but are not limited to, carbon black and graphite.

Suitable second current collectors include, but are not limited to, meshes, screens, and foils. Suitable materials for the second current collector include, but are not limited to, copper, nickel, and nickel-plated steel, stainless steel, titanium, and combinations thereof.

Suitable electrolytes include, but are not limited to, electrolytes having one or more salts dissolved in one or more solvents. Suitable salts include, but are not limited to, alkali metal salt including LiPF₆, LiBF₄, LiAsF₆, LiSbF₆, LiClO₄, LiAlCl₄, LiGaCl₄, LiC(SO₂CF₃)₃, LiNO₃, LiN(SO₂CF₃)₂, LiSCN, LiO₃SCF₂CF₃, LiC₆F₅SO₃, LiO₂CCF₃, LiSO₃F, LiB (C₆H₅)₄, LiCF₃SO₃, and mixtures thereof. Suitable solvents include, but are not limited to, aprotic organic solvents including low viscosity solvents and high permittivity solvents and mixture of aprotic organic solvents that include a low viscosity solvent and a high permittivity solvent. Suitable now viscosity solvents include, but are not limited to, esters, linear and cyclic ethers and dialkyl carbonates such as tetrahydrofuran (THF), methyl acetate (MA), diglyme, trigylme, tetragylme, dimethyl carbonate (DMC), 1,2-dimethoxy-ethane (DME), 1,2-diethoxyethane (DEE), 1-ethoxy,2-methoxyethane (EME), diethyl carbonate, ethyl methyl carbonate, and mixtures thereof. Suitable high permittivity solvents include, but are not limited to, cyclic carbonates, cyclic esters and cyclic amides such as propylene carbonate (PC), ethylene carbonate (EC), acetonitrile, dimethyl sulfoxide, dimethyl formamide, dimethyl acetamide, γ-valerolactone, γ-butyrolactone (GBL), N-methyl-pyrrolidinone (NMP), and mixtures thereof.

Suitable separators include, but are not limited to, fabrics woven from fluoropolymeric fibers including polyvinylidene fluoride, polyethylenetetrafluoroethylene, and polyethylenechlorotrifluoro-ethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C.H. Dexter, Div., Dexter Corp.).

In one example of the battery where the first electrode is a cathode and the second electrode is an anode, the first active medium includes silver vanadium oxide (SVO) as the first active material, polytetrafluoroethylene (PTFE) as the binder, and graphite and carbon black as electrical conductors; lithium metal as the second active medium; a polymeric separator; and an electrolyte that is 0.8M to 1.5M LiAsF₆ or LiPF₆ dissolved in a 50:50 mixture, by volume, of propylene carbonate as a preferred high permittivity solvent and 1,2-dimethoxyethane as a low viscosity solvent.

Before the plug is received in the opening, the container 84 can be filled with electrolyte transported into the interior of the container 84 through the opening. The plug can then be inserted into the opening. In some instances, the insertion of the plug in the opening includes rotating and/or twisting of the plug and the container relative to one another. When the plug includes a handle attached to a plug body, all or a portion of the handle can be separated from the plug body. The one or more regions of the plug and/or container where the sealing mechanism are to formed can optionally be cleaned. The sealing mechanism can be formed on the plug and/or container.

Although the opening and plug are disclosed as having a circular lateral shape in the context of FIG. 1B and FIG. 1D, other configurations are possible. For instance, the lateral shape can be square, rectangular, oval, or eliptical.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A battery, comprising:
a container that holds an electrode assembly, the container having an opening that extends from an external side of the container to an internal side of the container, and
a plug configured to be inserted into the opening,
the plug having a plug taper configured such that a width of the plug decreases linearly from an external side of the plug to an internal side of the plug, the plug taper being present on the plug before the plug is inserted into the opening.

2. The battery of claim 1, wherein the plug is received in the opening.

3. The battery of claim 2, wherein the external side of the plug is recessed relative to the external side of the container.

4. The battery of claim 1, wherein the opening has an opening taper configured such that a width of the opening decreases from an external side of the container to an internal side of the container.

5. The battery of claim 4, wherein the width of the opening decreases linearly from the external side of the container to the internal side of the container

6. The battery of claim 4, wherein the plug taper is complementary to the opening taper.

7. The battery of claim 4, wherein an opening taper angle is in a range of angles greater than 0 degrees and less than 10 degrees.

8. The battery of claim 4, wherein an interface between the plug taper and the opening taper is a self-holding taper.

9. The battery of claim 8, wherein the interface is a Jacobs taper or a Morse taper.

10. The battery of claim 4, wherein one or more lateral sides of the container define the opening, and
an interface between the plug and the one or more lateral sides includes a gap region where the one or more lateral sides are spaced apart from the plug and a contact region where the one or more lateral sides contact the plug,
the contact region being closer to the external side of the container than the gap region.

11. The battery of claim 10, wherein the gap region is open to an electrolyte within the container.

12. The battery of claim 4, wherein a weld contacts the external side of the container and the external side of the plug.

13. The battery of claim 1, wherein the plug includes a handle extending from a plug body.

14. The battery of claim 1, wherein the plug includes a pin extending from a plug body, the pin serving as a terminal for the battery.

15. A battery, comprising:
a container that holds an electrode assembly, the container having one or more lateral sides that define an opening that extends through from an external side of the container to an internal side of the container, and
a plug received in the opening, an interface between the plug and the lateral sides of the container being constructed as a self-holding taper.

16. The battery of claim 15, wherein the self-holding taper is a Jacobs taper or a Morse taper.

17. The battery of claim 15, wherein the plug includes a plug taper configured such that a width of the plug decreases linearly from an external side of the plug to an internal side of the plug.

18. The battery of claim 15, wherein the plug taper has a shape that is complementary to the opening in the container.

19. The battery of claim 17, wherein a plug taper angle is in a range of angles greater than 0 degrees and less than 10 degrees.

20. The battery of claim 15, wherein an interface between the plug and the one or more lateral sides includes a gap region where the one or more lateral sides are spaced apart from the plug and a contact region where the one or more lateral sides contact the plug,
the contact region being closer to the external side of the container than the gap region.
